(19) United States
(12) Patent Application Publication
(10) Pub. No.: US 2011/0069701 A1
(43) Pub. Date: Mar. 24, 2011

(54) GATEWAY AND METHOD FOR PROCESSING PACKETS UTILIZED THEREBY

(75) Inventor: DA-CHENG WU, Tu-Cheng (TW)

(73) Assignee: HON HAI PRECISION INDUSTRY CO., LTD., Tu-Cheng (TW)

(21) Appl. No.: 12/641,499

(22) Filed: Dec. 18, 2009

(30) Foreign Application Priority Data
Sep. 18, 2009 (CN) 200910307338.0

(51) Int. Cl. H04L 12/56; H04L 12/66

(52) U.S. Cl. 370/352; 370/411

(57) ABSTRACT

A gateway includes a plurality of line cards and a management board. One of the plurality of line cards connected to one user terminal transmits an Internet control message (ICM) packet with off-hook information of the user terminal. The management board receives the ICM packet with the off-hook information from the line card, and transmits a call request packet to the media gateway controller according to an Internet protocol (IP) address of the management board. The management board further receives a call response packet including a dial tone from the media gateway controller, and transmits an ICM packet with the dial tone to the line card connected to the user terminal. The line card connected to the user terminal further transmits the dial tone to the user terminal. Thus the signaling connection between the gateway and the media gateway controller is established.

### BACKGROUND

1. Technical Field

Embodiments of the present disclosure relate to network communications, and more particularly to a gateway and a method for processing packets utilized by the gateway.

2. Description of Related Art

Generally, a gateway is connected between a plurality of user terminals via a plurality of line cards, and a media gateway controller via a voice over Internet protocol (VoIP) network. The gateway provides VoIP service for the user terminals. Each line card requires an Internet protocol (IP) address to communicate with the media gateway controller. Therefore, the gateway requires many IP addresses, and thus has a small utilization ratio of the IP addresses.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment of a gateway in accordance with one embodiment the present disclosure;

FIG. 2 is a schematic diagram of one embodiment of a port mapping table of the gateway of FIG. 1.

FIG. 3 is a schematic diagram of functional modules of one embodiment of a line card of the gateway of FIG. 1;

FIG. 4 is a transport flow of one embodiment of a method for processing packets utilized in a gateway, such as, for example, that of FIG. 1; and

FIG. 5 is a flowchart showing one embodiment of the method for processing packets of FIG. 4.

### DETAILED DESCRIPTION

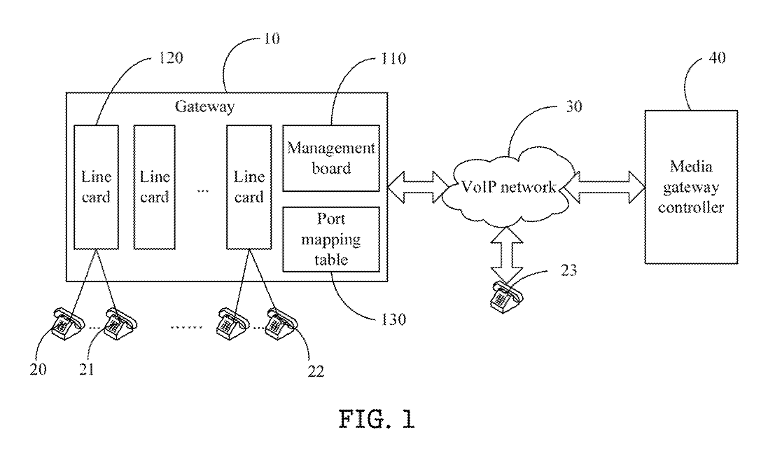

FIG. 1 is a schematic diagram of an application environment of a gateway 10 in accordance with one embodiment of the present disclosure. In this embodiment, the gateway 10 is connected between a plurality of user terminals 20, 21, 22, and a media gateway controller 40 and a user terminal 23 via a voice over Internet protocol (VoIP) network 30. To connect a caller user terminal connected to the gateway 10 to a callee user terminal (a telephone, for example), the gateway 10 establishes a signaling connection with the media gateway controller 40 when the caller user terminal is off-hook. The caller user terminal connected to the gateway 10 can dial the callee user terminal, that is, can transmit RTP packets to the callee user terminal.

In one embodiment, the gateway 10 includes a management board 110 and a plurality of line cards 120. The management board 110 is connected to the VoIP network 30, and includes an IP address and a media access control (MAC) address.

Each line card 120 includes a MAC address, a line card number, and a plurality of port numbers. The line card 120 is connected to the user terminals 20, 21 corresponding to the port numbers of the line card 120. The management board 110 may be a processor such as an IP main processor unit (MPU). The user terminals 20, 21, 22, 23 may be telephones, for example.

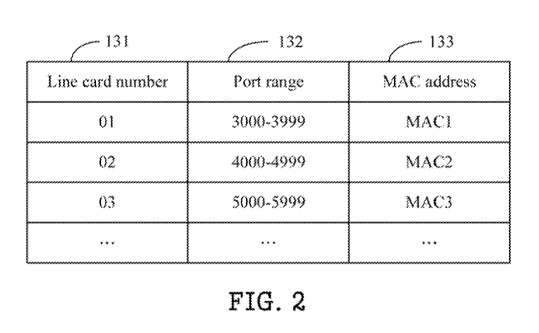

The management board 110 establishes a port mapping table 130 according to the port numbers, the line card number, and the MAC address of each line card 120 when the gateway 10 boots up, and notifies each line card 120 of the port mapping table 130. FIG. 2 is a schematic diagram of one embodiment of the port mapping table 130. The mapping table 130 includes a line card number field 131, a port range field 132, and a MAC address field 133, respectively for recording the line card number, the port numbers, and the MAC address of each line card 120. The port numbers of the same line card 120 belong to the same port range, and the port numbers of different line cards 120 do not belong to the same port range.

In one embodiment, the line card 120 that is connected to the user terminal 20 transmits an Internet control message (ICM) packet with off-hook information of the user terminal 20 to the management board 110 when the user terminal 20 is off-hook. The ICM packet with the off-hook information includes the line card number of the line card 120 and a port number corresponding to the user terminal 20. The user terminal 20 may want to call the user terminal 21, 22, or 23.

The management board 110 is operable to receive the ICM packet with the off-hook information of the user terminal 20 from the line card 120, and generate a user terminal identification number according to the line card number and the port number in the ICM packet with the off-hook information. In one embodiment, the management board 110 generates the user terminal identification number based on the following formula: (the line card number−1)*the number of the user terminals 20, 21 connected to the line card 120+the index of a source port number of the ICM packet with the off-hook information. The source port number of the ICM packet with the off-hook information is the port number corresponding to the user terminal 20. In one example, the gateway 10 includes 14 pieces of line cards 120, each connected to 48 user terminals 20, 21, and the index of the source port number of the ICM packet is 3. Then, the user terminal identification number of the user terminal 20 is calculated as: (2−1)*48+3=51.

The management board 110 is further operable to transmit a call request packet to the media gateway controller 40 over the VoIP network 30 according to the IP address of the management board 110 and the user terminal identification number. The call request packet includes the off-hook information of the user terminal 20. Accordingly the media gateway controller 40 sends back a call response packet to the management board 110. The call response packet includes a dial tone and the user terminal identification number.

The management board 110 receives the call response packet from the media gateway controller 40, and retrieves the port number corresponding to the user terminal 20 from the user terminal identification number in the call response packet. The management board 110 then transmits an ICM packet with the dial tone to the line card 120. The line card 120 receives the ICM packet with the dial tone from the management board 110, and transmits the dial tone to the user terminal 20 according to the port number corresponding to the user terminal 20. Then the user terminal 20 receives the dial tone and starts to dial telephone numbers to call another user terminal. Thus, the gateway 10 finishes establishing a signaling connection with the media gateway controller 40 using the IP address of the management board 110. Accordingly, the line card 120 requires no IP address.

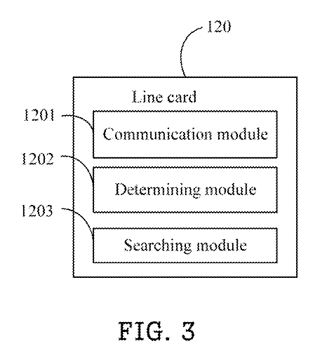

FIG. 3 is a schematic diagram of functional modules of one embodiment of the line card 120 of the gateway 10 of FIG. 1. In one embodiment, the line card 120 includes a communication module 1201, a determining module 1202, and a searching module 1203. The gateway 10 provides VoIP service for the user terminal after the signaling connection between the gateway 10 and the media gateway controller 40 has been established. That is, the gateway 10 can transmit an RTP packet from a caller user terminal to a callee user terminal. The caller user terminal and the callee user terminal may be any two of user terminals 20, 21, 22, 23.

The communication module 1201 is operable to receive the RTP packet from the caller user terminal. The RTP packet includes a source IP address, a destination IP address, a source port number, and a destination port number. In one embodiment, the communication module 1201 may directly receive the RTP packet from the user terminal 20 if the caller user terminal is the user terminal 20. The communication module 1201 may receive the RTP packet from the user terminal 22 via one line card connected to the user terminal 22 if the caller user terminal is the user terminal 22. The communication module 1201 may receive the RTP packet from the user terminal 23 over the VoIP network 30 if the caller user terminal is the user terminal 23.

The determining module 1202 is operable to determine whether the destination IP address is the same as the source IP address of the RTP packet, and further determine whether the source port number and the destination port number of the RTP packet belong to the same port range. In one embodiment, the port numbers of one line card belong to the same port range, and the port numbers of different line cards do not belong to the same port range.

If the destination IP address is the same as the source IP address, and the source port number and the destination port number of the RTP packet belong to the same port range, the caller user terminal and the callee user terminal may be respectively the user terminal 20 and the user terminal 21. Then, the communication module 1201 is further operable to directly transmit the RTP packet to the callee user terminal 21.

The determining module 1202 is further operable to determine whether the destination IP address of the RTP packet is the same as the IP address of the management board 110. In one embodiment, if the destination IP address of the RTP packet is not the same as the IP address of the management board 110, the RTP packet is transmitted from the gateway 10 to the VoIP network 30. In such a case, the caller user terminal and the callee user terminal may be the user terminal 20 and the user terminal 23. The communication module 1201 further requests the management board 110 to acquire a MAC address of the callee user terminal 23, and then transmits the RTP packet to the callee user terminal 23 according to the MAC address of the callee user terminal 23. In one embodiment, the management board 110 transmits an address resolution protocol (ARP) packet to the callee user terminal 23 to acquire the MAC address of the callee user terminal 23.

If the destination IP address is the same as the source IP address of the RTP packet, and the source port number and the destination port number of the RTP packet do not belong to the same port range, the caller user terminal and the callee user terminal are connected to the same gateway 10 and connected to different line cards. In such a case, the caller user terminal and the callee user terminal may be the user terminal 20 and the user terminal 22, respectively. Then, the searching module 1203 searches for a MAC address of one line card connected to the callee user terminal 22 in the port mapping table 130 of FIG. 1. The communication module 1201 further transmits the RTP packet to the callee user terminal 22 according to the MAC address of the line card connected to the callee partner user terminal 22.

If the destination IP address is the same as the IP address of the management board 110, the RTP packet is transmitted from the VoIP network 30 to the gateway 10. In such a case, the caller user terminal and the callee user terminal may be the user terminal 23 and the user terminal 20, respectively. The communication module 1201 further transmits the RTP packet to the callee user terminal 20 according to the destination port number of the RTP packet.

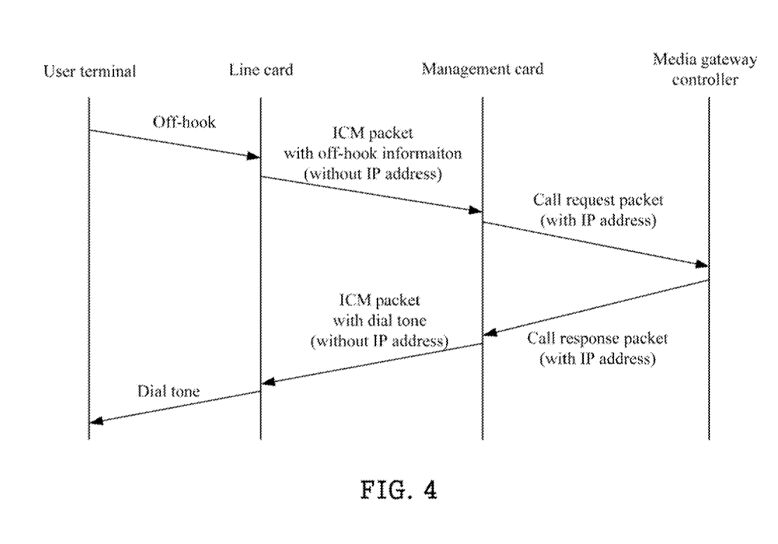

FIG. 4 is a transport flow of one embodiment of a method for processing packets utilized in a gateway, such as, for example, that of FIG. 1. In one embodiment, the gateway 10 establishes a signaling connection with the media gateway controller 40.

Initially, a user terminal 20 is off-hook and ready to establish a call with another user terminal. The line card 120 connected to the user terminal 20 transmits an ICM packet with the off-hook information of the user terminal 20 to the management board 110. In one embodiment, the ICM packet with the off-hook information includes the line card number of the line card 120 and the port number corresponding to the user terminal 20. The ICM packet with the off-hook information requires no IP address.

Then, the management board 110 receives the ICM packet with the off-hook information from the line card 120, and generates a user terminal identification number according to the line card number of the line card 120 and the port number corresponding to the user terminal 20 in the ICM packet with the off-hook information. The management board 110 transmits a call request packet to the media gateway controller 40 over the VoIP network 30 according to the IP address of the management board 110 and the user terminal identification number. The call request packet includes the off-hook information of the user terminal 20.

Afterwards, the media gateway controller 40 receives the call request packet, and sends back a call response packet to the management board 110. The call response packet includes a dial tone and the user terminal identification number.

Then, the management board 110 receives the call response packet from the media gateway controller 40, and retrieves the port number corresponding to the user terminal 20 from the user terminal identification number in the call response packet. The management board 110 transmits an ICM packet with the dial tone to the line card 120.

The line card 120 receives the ICM packet with the dial tone, and transmits the dial tone to the user terminal 20 according to the port number corresponding to the user terminal 20.

Finally, the user terminal 20 receives the dial tone from the line card 120. Thus, the signaling connection between the gateway 10 and the media gateway controller 40 is successfully established. Accordingly, the user terminal 20 can start a call with another user terminal.

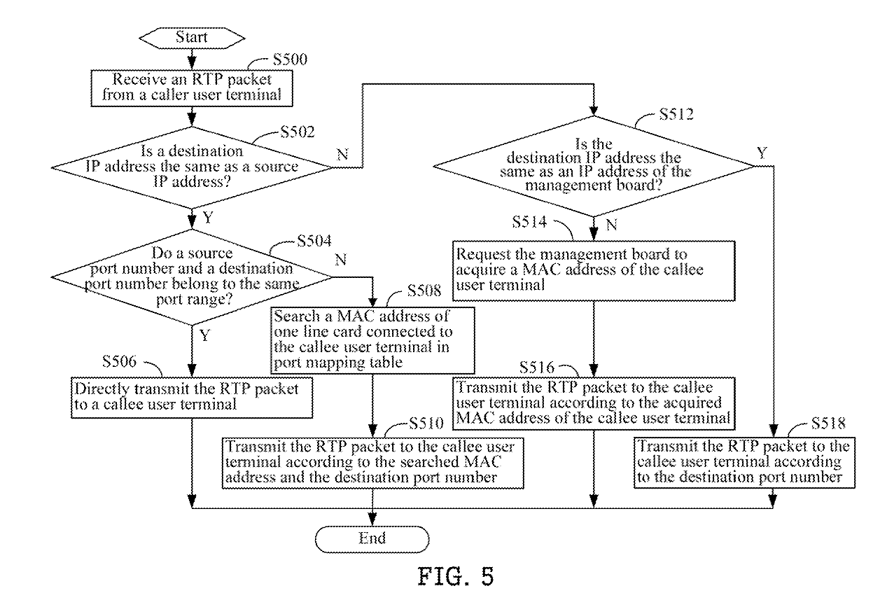

FIG. 5 is a flowchart of one embodiment of the method for processing packets of FIG. 4. Depending on the embodiment, additional blocks may be added, others may be deleted, and the ordering of the blocks may be changed. In one embodiment, the gateway 10 transmits an RTP packet from a caller user terminal to a callee user terminal. The caller user terminal and the callee user terminal may be any two of user terminals 20, 21, 22, 23.

In block S500, the communication module 1201 receives an RTP packet from a caller user terminal. In one embodiment, the communication module 1201 may directly receive the RTP packet from the user terminal 20 if the caller user terminal is the user terminal 20. The communication module 1201 may receive the RTP packet from the user terminal 22 via one line card connected to the user terminal 22 if the caller user terminal is the user terminal 22. The communication module 1201 may receive the RTP packet from the user terminal 23 over the VoIP network 30 if the caller user terminal is the user terminal 23. The RTP packet includes a source IP address, a destination IP address, a source port number, and a destination port number.

In block S502, the determining module 1202 determines whether the destination IP address is the same as the source IP address. In one embodiment, the caller user terminal and the callee user terminal are both connected to the gateway 10 if the source IP address is the same as the destination IP address.

If the destination IP address is the same as the source IP address, in block S504, the determining module 1202 further determines whether the destination port number and the source port number belong to the same port range according to the port mapping table 130.

The caller user terminal and callee user terminal are connected to one same line card if the destination port number and the source port number belong to the same port range. In such a case, in block S506, the communication module 1201 directly transmits the RTP packet to the callee user terminal.

If the destination port number and the source port number do not belong to the same port range, the caller user terminal and the callee user terminal are connected to different line cards. In such a case, in block S508, the searching module 1203 searches for a MAC address of one line card connected to the callee user terminal in the port mapping table 130.

In block S510, the communication module 1201 transmits the RTP packet to the callee user terminal according to the MAC address of the line card connected to the callee user terminal and the destination port number.

If the destination IP address is not the same as the source IP address, the user terminal and the partner are connected to different gateways. Thus, in block S512, the determining module 1202 further determines whether the destination IP address of the RTP packet is the same as the IP address of the management board 110.

If the destination IP address is the same as the IP address of the management board 110, the RTP packet is transmitted from the VoIP network 30 to the gateway 10. That is, the caller user terminal may be the user terminal 23.

If the destination IP address is not the same as the IP address of the management board 110, the RTP packet will transmitted from the gateway 10 to the VoIP network 30. That is, the callee user terminal may be the user terminal 23.

If the destination IP address is not the same as the IP address of the management board 110, in block S514, the communication module 1201 requests the management board 110 to acquire a MAC address of the callee user terminal. In one embodiment, the communication module 1201 transmits a request ICM packet to the management board 110. The management board 110 receives the request ICM packet, transmits an ARP packet to the callee user terminal to acquire the MAC address of the callee user terminal according to the request ICM packet, and then transmits a response ICM packet with the MAC address of the callee user terminal to the communication module 1201.

In block S516, the communication module 1201 transmits the RTP packet to the callee user terminal over the VoIP network 30 according to the MAC address of the callee user terminal.

If the destination IP address is the same as the IP address of the management board 110, in block S518, the communication module 1201 transmits the RTP packet to the callee user terminal according to the destination port number of the RTP packet.

Thus, the gateway 10 requires only one IP address of the management board 110, and does not need to prepare IP address for each line card 120, which improves the utilization rate of IP addresses.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A gateway operable to establish a signaling connection with a media gateway controller, the gateway comprising:
a plurality of line cards, each of the plurality of line cards comprising a line card number and at least one port number, each of the line cards being connected to at least one user terminal corresponding to at least one port number, the line cards operable to transmit an Internet control message (ICM) packet with off-hook information when one of the at least one user terminal connected to the line card is off-hook, wherein the ICM packet comprises the line card number of the line card connected to the user terminal and the port number corresponding to the user terminal;
a management board comprising an Internet protocol (IP) address, operable to receive the ICM packet with the off-hook information from the line card and generate a user terminal identification number according to the line card number and the port number in the ICM packet with the off-hook information;
wherein the management board transmits a call request packet to the media gateway controller according to the IP address of the management board and the user terminal identification number such that the media gateway controller sends back a call response packet, wherein the call request packet comprises the off-hook information of the user terminal, and the call response packet comprises a dial tone and the user terminal identification number;
wherein the management board further receives the call response packet from the media gateway controller, retrieves the port number corresponding to the user terminal from the user terminal identification number in the call response packet, and transmits an ICM packet with a dial tone to the line card connected to the user terminal;
wherein the line card receives the ICM packet with the dial tone, and transmits the dial tone to the user terminal according to the port number corresponding to the user terminal, so as to establish the signaling connection between the gateway and the media gateway controller.

2. The gateway as claimed in claim 1, wherein each line card comprises a MAC address, and the port numbers of each line card belong to the same port range.

3. The gateway as claimed in claim 2, further comprising a port mapping table operable to record the line card number, the MAC address, and the port numbers of each of the line cards.

4. The gateway as claimed in claim 3, wherein the line card of the gateway is further operable to transmit a real-time transport protocol (RTP) packet from a caller user terminal to a callee user terminal.

5. The gateway as claimed in claim 4, wherein the line cards each comprise:
a communication module operable to receive the RTP packet from the caller user terminal, the RTP packet comprising a source IP address, a destination IP address, a source port number, and a destination port number; and
a determination module operable to determine whether the destination IP address is the same as the source IP address and determine whether the destination port number and the source port number belong to the same port range;
wherein the communication module is further operable to directly transmit the RTP packet to the callee user terminal when the destination IP address is the same as the source IP address and the destination port number and the source port number belong to the same port range.

6. The gateway as claimed in claim 5, wherein the line card further comprises a searching module operable to search for a MAC address of one line card connected to the callee user terminal in the port mapping table when the destination IP address is the same as the source IP address and the destination port number and the source port number does not belong to the same port range.

7. The gateway as claimed in claim 6, wherein the communication module is further operable to transmit the RTP packet to the callee user terminal according to the MAC address of the line card connected to the callee user terminal and the destination port number of the RTP packet.

8. The gateway as claimed in claim 5, wherein the determining module is further operable to determine whether the destination IP address of the RTP packet is the same as the IP address of the management board.

9. The gateway as claimed in claim 8, wherein the communication module is further operable to request the management board to acquire a MAC address of the callee user terminal when the destination IP address is not the same as the source IP address and the destination IP address is not the same as the IP address of the management board.

10. The gateway as claimed in claim 9, wherein the communication module is further operable to transmit the RTP packet to the callee user terminal according to the MAC address of the callee user terminal.

11. The gateway as claimed in claim 8, wherein the communication module is further operable to transmit the RTP packet to the callee user terminal according to the destination port number of the RTP packet when the destination IP address is not the same as the source IP address and the destination IP address is the same as the IP address of the management board.

12. A method for processing packets utilized in a gateway, the gateway establishing a signaling connection with a media gateway controller, the gateway comprising a plurality of line cards and a management board, each of the plurality of line cards comprising a line card number and at least one port number, each of the line cards being connected to at least one user terminal corresponding to at least one port number, and the management board comprising an Internet protocol (IP) address, the method comprising:
one line card connected to one user terminal transmitting an Internet control message (ICM) packet with off-hook information of the user terminal to the management board when the user terminal is off-hook, wherein the ICM packet with the off-hook information comprises the line card number of the line card connected to the user terminal and the port number corresponding to the user terminal;
the management board receiving the ICM packet with the off-hook information from the line card and generating a user terminal identification number according to the line card number and the port number in the ICM packet with the off-hook information;
the management board transmitting a call request packet to the media gateway controller according to the IP address of the management board and the user terminal identification number in order that the media gateway controller sends back a call response packet, wherein the call request packet comprises the off-hook information of the user terminal, and the call response packet comprises a dial tone and the user terminal identification number;
the management board receiving the call response packet from the media gateway controller and retrieving the port number corresponding to the user terminal from the user terminal identification number in the call response packet;
the management board transmitting an ICM packet with the dial tone to the line card connected to the user terminal; and
the line card connected to the user terminal receiving the ICM packet with the dial tone and transmitting the dial tone to the user terminal according to the port number corresponding to the user terminal, so as to establish the signaling connection between the gateway and the media gateway controller.

13. The method as claimed in claim 12, further comprising:
the line card of the gateway transmitting a real-time transport protocol (RTP) packet from a caller user terminal to a callee user terminal.

14. The method as claimed in claim 13, wherein the block of the line card of the gateway transmitting an RTP packet from a caller user terminal to a callee user terminal comprises:
the line card receiving the RTP packet from the caller user terminal, wherein the RTP packet comprises a source IP address, a destination IP address, a source port number, and a destination port number;
the line card determining whether the destination IP address is the same as the source IP address;
the line card determining whether the source port number and the destination port number belong to the same port range if the destination IP address is the same as the source IP address; and
the line card directly transmitting the RTP packet to the callee user terminal if the source port number and the destination port number belong to the same port range.

15. The method as claimed in claim 14, wherein the gateway further comprises a port mapping table operable to record the line card number, the port numbers, and a MAC address of each of the line cards.

16. The method as claimed in claim 15, wherein the block of the line card of the gateway transmitting an RTP packet from a caller user terminal to a callee user terminal further comprises:
the line card searching for a MAC address of one line card connected to the callee user terminal in the port mapping table if the source port number and the destination port number do not belong to the same port range; and
the line card transmitting the RTP packet to the callee user terminal according to the searched MAC address of the line card connected to the callee user terminal and the port number corresponding to the callee user terminal.

17. The method as claimed in claim 15, wherein the block of the line card of the gateway transmitting an RTP packet from a caller user terminal to a callee user terminal further comprises:
the line card determining whether the destination IP address is the same as the IP address of the management board if the destination IP address is not the same as the source IP address; and
the line card transmitting the RTP packet to the callee user terminal according to the destination port number if the destination IP address is the same as the IP address of the management board.

18. The method as claimed in claim 17, wherein the block of the line card of the gateway transmitting an RTP packet from a caller user terminal to a callee user terminal further comprises:
the line card requesting the management board to acquire a MAC address of the callee user terminal if the destination IP address is not the same as the IP address of the management board; and
the line card transmitting the RTP packet to the callee user terminal according to the searched MAC address of the callee user terminal.
